(19) United States
(12) Patent Application Publication
(10) Pub. No.: US 2025/0175810 A1
(43) Pub. Date: May 29, 2025

(54) METHODS, DEVICES, AND COMPUTER READABLE MEDIUM FOR COMMUNICATION

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/725,362

(22) PCT Filed: Jan. 28, 2022
(86) PCT No.: PCT/CN2022/074732

§ 371 Date: Jun. 28, 2024

(30) Foreign Application Priority Data
Dec. 31, 2021 (WO) PCT/CN2021/143900

(51) Int. Cl. H04W 16/14; H04L 1/18; H04W 92/18

(52) U.S. Cl. CPC H04W 16/14; H04L 1/18; H04W 92/18

(57) ABSTRACT

Embodiments of the present disclosure relate to methods, devices, and computer readable medium for communication. According to embodiments of the present disclosure, a first terminal device transmits a sidelink configuration to a set of terminal devices. The sidelink configuration indicates that one sidelink transmission corresponds to a set of sidelink feedback reception occasions and the sidelink configuration also indicates that a sidelink feedback type for the sidelink transmission is negative acknowledgement only (NACK-only). The first terminal device transmits a set of sidelink transmissions to the set of terminal devices. If no sidelink feedback is detected on the last set of sidelink feedback reception occasions of the plurality of sets of sidelink feedback reception occasions, the first terminal device transmits an uplink transmission which indicates an acknowledgement for the set of sidelink transmissions to the network device. In this way, it achieves reporting SL HARQ-ACK in PUCCH/PUSCH when multiple PSFCH are associated with one PSSCH transmission.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, device to device (D2D)/sidelink communication has been proposed. Sidelink is a special kind of communication mechanism between device and device without going through eNB. In some cases, the resources for sidelink communication may be in unlicensed bands. Sidelink in unlicensed spectrum or band (SL-U) is a key topic in Release 18 of the 3rd Generation Partnership Project (3GPP). The scheme of SL-U should base on New Radio (NR) sidelink and NR-U. Sidelink Hybrid Automatic Repeat Request (HARQ) feedback information associated with a sidelink data transmission should be reported to a terminal device transmitting the sidelink data transmission on a feedback channel resource. The feedback channel resource is a dedicated resource for sidelink HARQ feedback within a sidelink resource pool. To ensure performance of sidelink HARQ feedback, more feedback channel resources should be provided in SL-U.

### SUMMARY

In general, example embodiments of the present disclosure provide a solution for communication.

In a first aspect, there is provided a method for communication. The communication method comprises: transmitting, at a first terminal device and to a set of terminal devices, a sidelink configuration, wherein the sidelink configuration indicates that one sidelink transmission corresponds to one set of sidelink feedback reception occasions and the sidelink configuration also indicates that a sidelink feedback type for the sidelink transmission is negative acknowledgement only (NACK-only); transmitting a set of sidelink transmissions to the set of terminal devices; and in accordance with a determination that no sidelink feedback is received on the last set of sidelink feedback reception occasions in a plurality of sets of sidelink feedback reception occasions associated with the set of sidelink transmissions, transmitting, to a network device, an uplink transmission indicating an acknowledgement for the set of sidelink transmissions.

In a second aspect, there is provided a method for communication. The communication method comprises: receiving, at a second terminal device and from a first terminal device, a sidelink configuration, wherein the sidelink configuration indicates that one sidelink transmission corresponds to one set of sidelink feedback reception occasions and the sidelink configuration also indicates that a sidelink feedback type for the sidelink transmission is negative acknowledgement only (NACK-only); and receiving a set of sidelink transmissions from the first terminal device.

In a third aspect, there is provided a terminal device. The terminal device comprises a processing unit; and a memory coupled to the processing unit and storing instructions thereon, the instructions, when executed by the processing unit, causing the terminal device to perform acts comprising: transmitting, to a set of terminal devices, a sidelink configuration, wherein the sidelink configuration indicates that one sidelink transmission corresponds to one set of sidelink feedback reception occasions and the sidelink configuration also indicates that a sidelink feedback type for the sidelink transmission is negative acknowledgement only (NACK-only); transmitting a set of sidelink transmissions to the set of terminal devices; and in accordance with a determination that no sidelink feedback is received on the last set of sidelink feedback reception occasions in a plurality of sets of sidelink feedback reception occasions associated with the set of sidelink transmissions, transmitting, to a network device, an uplink transmission indicating an acknowledgement for the set of sidelink transmissions.

In a fourth aspect, there is provided a terminal device. The terminal device comprises a processing unit; and a memory coupled to the processing unit and storing instructions thereon, the instructions, when executed by the processing unit, causing the terminal device to perform acts comprising: receiving, from a first terminal device, a sidelink configuration, wherein the sidelink configuration indicates that one sidelink transmission corresponds to one set of sidelink feedback reception occasions and the sidelink configuration also indicates that a sidelink feedback type for the sidelink transmission is negative acknowledgement only (NACK-only); and receiving a set of sidelink transmissions from the first terminal device.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 is a schematic diagram of a communication environment in which embodiments of the present disclosure can be implemented;

FIG. 3 illustrates a signaling flow for communications according to some embodiments of the present disclosure;

FIG. 4 illustrates a schematic diagram of a structure of slots according to some embodiments of the present disclosure;

FIG. 5 illustrates a schematic diagram of a structure of slots according to some embodiments of the present disclosure;

FIG. 6 illustrates a schematic diagram of a structure of slots according to some embodiments of the present disclosure;

FIGS. 7A to 7G illustrate an example of timing line between a sidelink data transmission on PSSCH and a PSFCH resource, respectively in accordance with some embodiments of the present disclosure;

FIGS. 8A to 8D illustrate an example of timing line between a sidelink data transmission on PSSCH and a PSFCH resource, respectively in accordance with some embodiments of the present disclosure;

FIGS. 9A to 9E illustrate an example of PSFCH resource allocation, respectively in accordance with some embodiments of the present disclosure;

FIG. 10 is a flowchart of an example method in accordance with an embodiment of the present disclosure;

FIG. 11 is a flowchart of an example method in accordance with an embodiment of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.”

The terms “first,” “second,” and the like may refer to different or same objects. Other definitions, explicit and implicit, may be included below. In some embodiments, the terms “first,” “second,” and the like may be used to distinguish different objects, elements, or the like. For example, the first number and the second number mentioned in embodiments of the present disclosure can refer to different numbers. It should be understood that in some embodiments, the first number and the second number may have the same value, and in some other embodiments, the first number and the second number may have different value. In some other embodiments, the terms “first,” “second,” and the like may represent an ordered position of an element or object in multiple elements or objects. For example, the term “the first sidelink feedback reception occasion” used herein refers to the starting sidelink feedback reception occasion in time domain. Those skilled in the art would understand exact meanings of the terms “first,” “second,” and the like according to context of the description.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

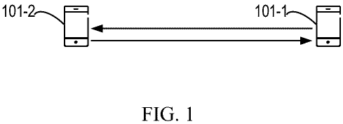

As mentioned above, the resources for sidelink (SL) communication may be in unlicensed bands. According to some conventional technologies, resources for sidelink communications can be scheduled by a network device, which is referred to as mode 1. On the other hand, resources for sidelink communication can also be determined by UE itself, which is referred to as mode 2. FIG. 1 illustrates an example schematic diagram of a system where inter-UE coordination for sidelink UE is performed between a pair of UEs. As shown in FIG. 1, UE 101-1 and UE 101-2 can perform sidelink communications with each other, each UE can act as either a transmitting (TX) UE or a receiving (RX) UE. For example, in the case where the UE 101-2 acts as a RX UE, when performing inter-UE coordination, the UE 101-2 can provide a set of resources to its peer UE, i.e. the TX UE 110-1. In this example, the UE 101-2 is being referred to as an assisting UE while the UE 101-1 is referred to as an assisted UE. The term “TX UE” used herein can refer to a UE which can transmit data to another UE when performing sidelink communications with the other UE. The term “RX UE” used herein can refer to a UE which can receive data from another UE when performing sidelink communications with the other UE.

According to conventional technologies, for SL configured grant Type 1 or Type 2 physical sidelink shared channel (PSSCH) transmissions by a UE within a time period, the UE generates one hybrid automatic repeat request-acknowledgement (HARQ-ACK) information bit in response to the physical sidelink feedback channel (PSFCH) receptions to multiplex in a physical uplink control channel (PUCCH) transmission occasion that is after a last time resource, in a set of time resources. For PSSCH transmissions scheduled by a DCI format 3_0, a UE generates HARQ-ACK information in response to PSFCH receptions to multiplex in a PUCCH transmission occasion that is after a last time resource in a set of time resources provided by the DCI format 3_0. For one or more PSFCH reception occasions associated with SCI format 2-B or SCI format 2-A with Cast type indicator field value of “11”, the UE generates an ACK when the UE determines absence of PSFCH reception for the last PSFCH reception occasion from the number of PSFCH reception occasions corresponding to PSSCH transmissions.

Moreover, according to some conventional technologies, one PSSCH can correspond to a plurality of PSFCH transmissions. However, it may cause some unexpected issues. For example, when multiple PSFCHs are associated with one PSSCH transmission and when UE generates an ACK/NACK based on the last PSFCH reception occasion, the ACK/NACK may be not accurate since some PSFCH receptions are omitted.

According to embodiments, solutions on sidelink feedbacks are proposed. According to embodiments of the present disclosure, a first terminal device transmits a sidelink configuration to a set of terminal devices. The sidelink configuration indicates that one sidelink transmission corresponds to a set of sidelink feedback reception occasions and the sidelink configuration also indicates that a sidelink feedback type for the sidelink transmission is negative acknowledgement only (NACK-only). The first terminal device transmits a set of sidelink transmissions to the set of terminal devices. The first terminal device monitors sidelink feedbacks for the set of sidelink transmissions on a plurality of sidelink feedback reception occasions. If no sidelink feedback is detected on the last set of sidelink feedback reception occasions of the plurality of sidelink feedback reception occasions, the first terminal device transmits an uplink transmission which indicates an acknowledgement for the set of sidelink transmissions to the network device. In this way, it achieves reporting SL HARQ-ACK in PUCCH/PUSCH when multiple PSFCH are associated with one PSSCH transmission.

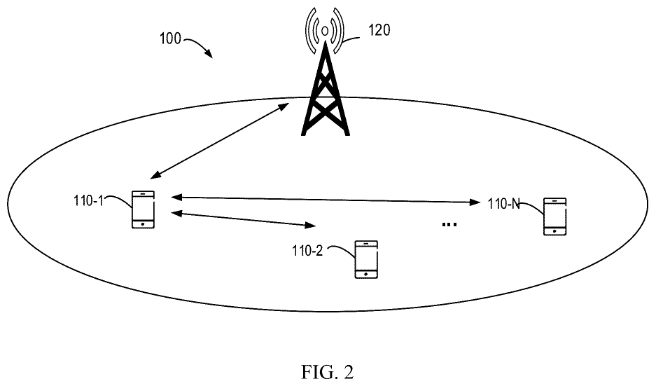

FIG. 2 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number. The terminal devices 110 can communicate with each other via sidelink.

The communication system 100 further comprises a network device. In the communication system 100, the network device 120 and the terminal devices 110 can communicate data and control information to each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

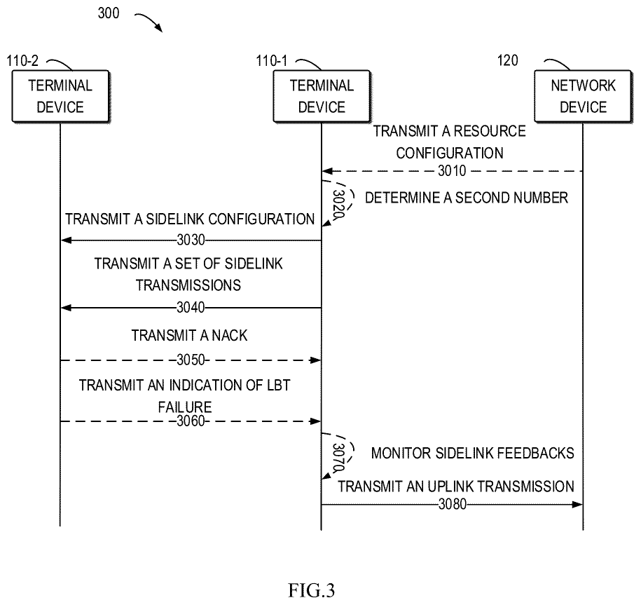

Embodiments of the present disclosure will be described in detail below. Reference is first made to FIG. 3, which shows a signaling chart illustrating process 300 between the terminal device and the network device according to some example embodiments of the present disclosure. Only for the purpose of discussion, the process 300 will be described with reference to FIG. 2. The process 300 may involve the terminal device 110-1, the terminal device 110-2 and the network device 120 in FIG. 2.

In some embodiments, the network device 120 may transmit 3010 a resource configuration of sidelink transmissions to the terminal device 110-1. In some embodiments, the resource configuration may indicate a resource pool allocated for the sidelink transmissions. The term “resource pool” used herein can refer to a subset of available subframes and resource blocks for either sidelink transmission or reception. Sidelink communication is a half-duplex scheme and a UE can be configured with multiple transmit resource pools and multiple receive resource pools.

In some embodiments, the resource configuration may comprise parameters which are used to manage resource selection. For example, the resource configuration may indicate resources for PSCCH value, for example, PSCCH subframes and resource blocks. Alternatively or in addition, the resource configuration may comprise a time resource pattern index which indicates PSSCH subframes. In some other embodiments, the resource configuration may comprise resource allocation parameters which indicate PSSCH resource blocks.

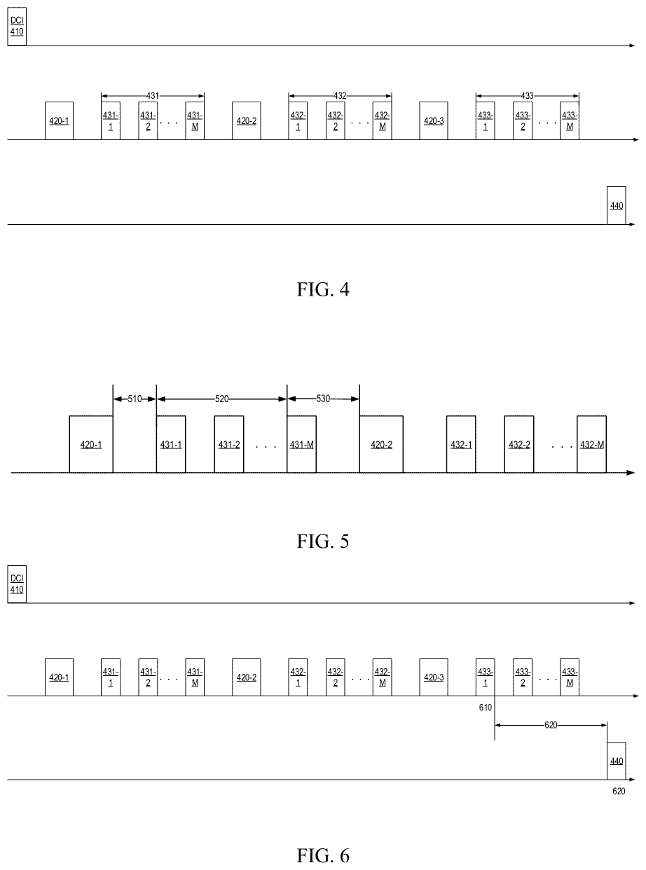

In some embodiments, the resource configuration can indicate the first number of sidelink feedback reception occasions in a set of sidelink feedback reception occasions. In other words, the resource configuration may indicate that one sidelink transmission can correspond to the first number of sidelink feedback reception occasions. For example, if the first number is M, it means that one sidelink transmission is associated with M sidelink feedback reception occasions. Referring to FIG. 4, if the PSSCH 420-1 is transmitted, the PSFCH reception occasions 431-1, 431-2, . . . , and 431-M are associated with the PSSCH 420-1.

In some embodiments, the first number of sidelink feedback reception occasions can be configured per carrier. Alternatively, the first number of sidelink feedback reception occasions can be configured per bandwidth part (BWP). In some other embodiments, the first number of sidelink feedback reception occasions can be configured per resource pool. Alternatively, the first number of sidelink feedback reception occasions can be predefined at the terminal device 110-1.

Alternatively, the terminal device 110-1 may determine 3020 the second number of sidelink feedback reception occasions in the set of sidelink feedback reception occasions. For example, the terminal device 110-1 may determine the second number of sidelink feedback reception occasions based on a traffic packet delay budget (PDB). The Packet Delay Budget can be described as an upper bound for the time that a packet may be delayed between the UE and the PCEF (Policy and Charging Enforcement Function). In this case, if the PDB is increased, the second number can be decreased. In other words, the larger PDB can be with the smaller second number.

In other embodiments, the terminal device 110-1 may determine the second number of sidelink feedback reception occasions based on a priority of the set of sidelink transmissions. In this case, if the set of sidelink transmissions has a higher priority, the second number of sidelink feedback reception occasions can be larger. In other words, the higher priority can be with the larger second number.

The terminal device 110-1 transmits 3030 a sidelink configuration to the terminal device 110-2. The sidelink configuration also indicates that a sidelink feedback type for the sidelink transmission is negative acknowledgement only (NACK-only).

The sidelink configuration indicates that one sidelink transmission corresponds to one set of sidelink feedback reception occasions. In some embodiments, the sidelink configuration can indicate the first number of sidelink feedback reception occasions in the set of sidelink feedback reception occasions. As mentioned above, the terminal device 110-1 may determine the second number of sidelink feedback reception occasions. In this case, the sidelink configuration can indicate the second number of sidelink feedback reception occasions in the set of sidelink feedback reception occasions. For example, the sidelink configuration can indicate that there are M sidelink feedback reception occasions in the set of sidelink feedback reception occasions. Referring to FIG. 4, the set of PSFCH reception occasions 431 can comprise PSFCH reception occasions 431-1, 431-2, . . . , and 431-M. The set of PSFCH reception occasions 432 can comprise PSFCH reception occasions 432-1, 432-2, . . . , and 432-M. The set of PSFCH reception occasions 433 can comprise PSFCH reception occasions 433-1, 433-2, . . . , and 433-M.

Referring back to FIG. 3, the terminal device 110-1 transmits 3040 a set of sidelink transmissions to the set of terminal devices (for example, the terminal device 110-2 as shown in FIG. 3). For example, as shown in FIG. 4, the network device 120 may transmit downlink control information (DCI) 410 to the terminal device 110-1. The DCI 410 can schedule the sidelink transmissions. As shown in FIG. 4, the terminal device 110-1 may transmit the PSSCHs 420-1, 420-2 and 420-3. The PSSCHs 420-2 and 420-3 can be repetitions of the PSSCH 420-1. It should be noted that the number of PSSCHs is only an example.

In some embodiments, a time gap between two adjacent sidelink transmissions in the set of sidelink transmissions can comprise: a first time gap between an end of a last symbol of a first sidelink transmission of the set of sidelink transmissions and a start of a first symbol of a starting sidelink feedback reception in the set of sidelink feedback reception occasions, a second time gap between a first symbol of the starting sidelink feedback reception occasion and a first symbol of the last sidelink feedback reception occasion in the set of sidelink feedback reception occasions, and a third time gap required for the last sidelink feedback reception and processing plus sidelink retransmission preparation. Referring to FIG. 5, the time gap between the PSSCHs 420-1 and 420-2 can comprise the time gap 510, the time gap 520 and the time gap 530. The time gap 510 can be a time gap between the end of the last symbol of a PSSCH transmission 420-1 of the first resource and the start of the first symbol of the corresponding first PSFCH reception 431-1 determined by sl-MinTimeGapPSFCH and sl-PSFCH-Period for the pool of resources within the M PSFCH reception occasions. The time gap 520 can be a time gap between a first symbol of the first PSFCH reception occasion 431-1 and the first symbol of last PSFCH reception occasion 431-M. The time gap 530 can be a time required for the last PSFCH reception occasion 431-M and processing plus sidelink retransmission preparation including multiplexing of necessary physical channels and any TX-RX/RX-TX switching time.

In some embodiments, the time gap between the start of a PSCCH/PSSCH slot and the start symbol of the last PSFCH associated with a preceding PSCCH/PSSCH slot in the same CG or in the set of resources indicated by one DCI should be larger than a predefined duration T_m (for example, the time gap 530). T_m can comprise PSFCH reception and processing plus sidelink retransmission preparation including multiplexing of necessary physical channels and any TX-RX/RX-TX switching time.

As mentioned above, the sidelink configuration indicates that the sidelink feedback type is NACK only. In this case, if the terminal device 110-2 cannot decode or receive the sidelink transmission from the terminal device 110-1, the terminal device 110-2 may transmit 3050 a NACK. Alternatively, if the terminal device 110-2 successfully decodes or receives the sidelink transmission from the terminal device 110-1, the terminal device 110-2 may not transmit any feedback to the terminal device 110-1.

Referring to FIG. 4, if the terminal device 110-2 cannot decode or receive the PSSCH 420-1, the terminal device 110-2 may transmit the NACK on any one of the PSFCH reception occasions 431-1, 431-2, . . . , and 431-M. In some embodiments, the sidelink configuration may further indicate a scheme for reporting ACK/NACK on multiple resources. For example, the sidelink configuration may indicate that a sidelink feedback for the sidelink transmission needs to be transmitted on each of the set of sidelink feedback reception occasions. In this case, if the terminal device 110-2 cannot decode or receive the PSSCH 420-1, the terminal device 110-2 may transmit the NACK on all of the PSFCH reception occasions 431-1, 431-2, . . . , and 431-M. Similarly, if the terminal device 110-2 cannot decode or receive the PSSCH 420-2, the terminal device 110-2 may transmit the NACK on any one of or all of the PSFCH reception occasions 432-1, 432-2, . . . , and 432-M. If the terminal device 110-2 cannot decode or receive the PSSCH 420-3, the terminal device 110-2 may transmit the NACK on any one of or all of the PSFCH reception occasions 433-1, 433-2, . . . , and 433-M. Details of schemes for reporting ACK/NACK on multiple resources are described later.

In some embodiments, the terminal device 110-2 may perform a listen-before-talk or a clear channel assessment (CCA) before the transmission of the NACK. The term “listen-before-talk (LBT)” used herein can refer to a technique used in radio communications whereby a radio transmitter senses its radio environment before it starts a transmission. LBT can be used by a radio device to find a network the device is allowed to operate on or to find a free radio channel to operate on. The term “clear channel assessment (CCA)” used herein refers to a technique to appraise the RF medium. The CCA may involve listening for RF transmissions at the Physical layer radios use a CCA threshold when listening to the RF medium. For example, energy detection may be used in the CCA. The energy detection (ED) threshold is used to detect any other type of RF transmissions during the CCA. If energy detected on the channel is less than an energy detection threshold, the channel can be regarded as available for performing transmissions. If the energy detected on the channel is larger than an energy detection threshold, the channel can be regarded as busy. For example, the terminal device 110-2 may determine a result of the LBT (or CCA) on the unlicensed spectrum band based on a difference between the energy of the sidelink transmission on the unlicensed spectrum band and a measured energy of the LBT (or CCA). For example, if the difference is within a threshold difference, the LBT may be considered as successfully to acquire the COT by the terminal device 310-1. In other words, if the energy detection in the LBT is similar as the calculated energy level of monitored SL-U transmission, the LBT may be considered as successfully to acquire the COT by COT initiating device. Alternatively, if the energy detection in the LBT is higher than the calculated energy level of monitored SL-U transmission beyond the configured threshold, the LBT may be considered as a failure.

If the LBT is successful, the terminal device 110-2 may transmit 3050 the NACK to the terminal device 110-1. Alternatively, if the LBT is failed, the terminal device 110-2 may transmit 3060 an indication of the LBT failure to the terminal device 110-1. For example, in some embodiments, the terminal device 110-2 may transmit SCI indicating the LBT failure to the terminal device 110-1. In some other embodiments, the terminal device 110-2 may transmit a PSSCH or PSCCH indicating the LBT failure to the terminal device 110-1. Alternatively, the terminal device 110-2 may transmit a medium access control (MAC) control element (CE) indicating the LBT failure to the terminal device 110-1. In other embodiments, the terminal device 110-2 may transmit a PC5-radio resource control (RRC) signaling indicating the LBT failure to the terminal device 110-1.

The terminal device 110-1 can monitor 3070 sidelink feedbacks for the set of sidelink transmissions on a plurality of sets of sidelink feedback reception occasions. For example, referring to FIG. 4, the terminal device 110-1 can monitor the sidelink feedback for the PSSCH 420-1 on the PSFCH reception occasions 431-1, 431-2, . . . , and 431-M. The terminal device 110-1 can monitor the sidelink feedback for the PSSCH 420-2 on the PSFCH reception occasions 432-1, 432-2, . . . , and 432-M. The terminal device 110-1 can monitor the sidelink feedback for the PSSCH 420-3 on the PSFCH reception occasions 433-1, 433-2, . . . , and 433-M.

The terminal device 110-1 transmits 3080 an uplink transmission to the network device 120. The uplink transmission indicates an ACK or NACK for the set of sidelink transmissions. In some embodiments, the uplink transmission can be transmitted within a slot with a slot offset. In this case, the slot can be the slot of a starting sidelink feedback reception occasion in the last set of sidelink feedback reception occasions and the slot offset can be larger than the number of slots which are occupied by the last set of sidelink feedback reception occasions. Referring to FIG. 6, the first sidelink feedback reception occasion 433-1 in the set of sidelink feedback reception occasions 433 is in slot 610. The terminal device can transmit the uplink transmission in slot 630. In this case, the time gap 620 between the slots 610 and 630 can comprise k slots. In other words, with reference to slots for PUCCH transmissions and for a number of PSFCH reception occasions, the terminal device 110-1 can provide the generated HARQ-ACK information in a PUCCH transmission within slot n+k, where slot n is the slot of the first PSFCH reception occasion associated with the last PSCCH/PSSCH resource of the set of resources indicated in a dynamic grant or configured grant where k is a number of slots indicated by a PSFCH-to-HARQ_feedback timing indicator field, if present, in a DCI format indicating a slot for PUCCH transmission to report the HARQ-ACK information, or k is provided by sl-PSFCH-ToPUCCH for a transmission scheduled by a DCI format or for a SL configured grant type 2, or by sl-PSFCH-ToPUCCH-CG-Type1 for a SL configured grant type 1. k=0 corresponds to a last slot for a PUCCH transmission that would overlap with the last PSFCH reception occasion assuming that the start of the sidelink frame is same as the start of the downlink frame.

If no sidelink feedback is received on the last set of sidelink feedback reception occasions of the plurality of sets of sidelink feedback reception occasions associated with the set of sidelink transmissions, the terminal device 110-1 transmits 3080 the uplink transmission indicating an acknowledgement for the set of sidelink transmissions. Referring to FIG. 4, when the terminal device 110-1 determines an absence of PSFCH reception (i.e., NACK from other terminal devices) for all/each of the last M PSFCH reception occasions (i.e., the set 433 of PSFCH reception occasions) from the plurality of PSFCH reception occasions corresponding to the PSSCHs 420-1, 420-2 and 420-3, the terminal device 110-1 may generate an ACK. In this case, the uplink transmission 440 can indicate the ACK. The plurality of PSFCH reception occasions can comprise PSFCH reception occasions 431-1, 431-2, . . . , and 431-M, PSFCH reception occasions 432-1, 432-2, . . . , and 432-M, and PSFCH reception occasions 433-1, 433-2, . . . , and 433-M.

Alternatively, in some embodiments, if at least one sidelink feedback is received on the last set of sidelink feedback reception occasions, the terminal device 110-1 transmits 3080 the uplink transmission indicating a NACK for the set of sidelink transmissions. Referring to FIG. 4, when the terminal device 110-1 detects one or more PSFCH receptions on the last M PSFCH reception occasions (i.e., the set 433 of PSFCH reception occasions) from the plurality of PSFCH reception occasions corresponding to the PSSCHs 420-1, 420-2 and 420-3, the terminal device 110-1 may generate a NACK. In this case, the uplink transmission 440 can indicate the NACK.

As mentioned above, the terminal device 110-2 may transmit the indication of the LBT failure. In this case, in some embodiments, the terminal device 110-1 may transmit the uplink transmission indicating the NACK for the set of sidelink transmissions. Alternatively, the uplink transmission may indicate HARQ-ACK information which is preconfigured by the network device 120. In other words, for reporting HARQ-ACK information on uplink corresponding to one or multiple PSSCH transmissions, the terminal device 110-1 may generate HARQ-ACK information with the contents instructed by higher layer, if the terminal device 110-1 is informed of contiguous LBT/access failure of the associated receiver terminal devices. The priority value of the HARQ-ACK information can be same as the priority value of the PSSCH transmission. In some other embodiments, the terminal device 110-1 may generate a NACK when the terminal device 110-1 does not receive PSFCH in any PSFCH reception occasion associated with a PSSCH transmission in a resource provided by a DCI format 3_0 or, for a configured grant, in a resource provided in a single period and for which the terminal device 110-1 is provided a PUCCH resource to report HARQ-ACK information and is informed of contiguous LBT/access failure of the associated receiver terminal devices. The priority value of the NACK is same as the priority value of the PSSCH transmission.

As mentioned above, the sidelink configuration may indicate a scheme for reporting ACK/NACK on multiple resources. If NACK only is selected and multiple PSFCH reception/transmission occasions are associated with one PSSCH transmission/reception, the first scheme where the NACK feedback is transmitted on all the available PSFCH resource can be selected. In this case, the sidelink configuration may indicate the first scheme. In other words, if the first scheme is selected/enabled, the terminal device 110-1 can select positive-negative acknowledgement or negative-only acknowledgement. Alternatively, if positive-negative acknowledgement is selected and multiple PSFCH reception/transmission occasions are associated with one PSSCH transmission/reception, either the first scheme or the second scheme where once A/N is reported the Rx terminal device may not transmit on the remaining available PSFCH resources can be selected. In other words, if the second scheme is selected/enabled, the terminal device 110-1 can select positive-negative acknowledgement. In some embodiments, the first scheme or the second scheme can be configured by the network device 120.

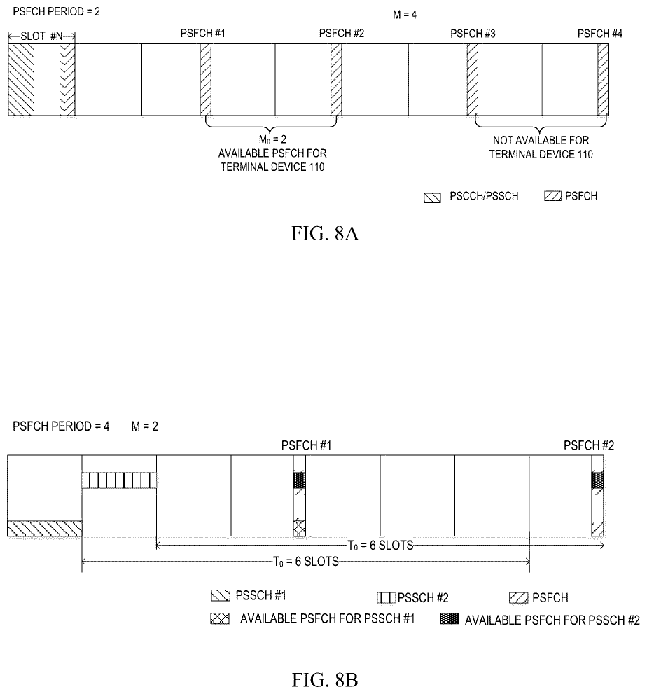

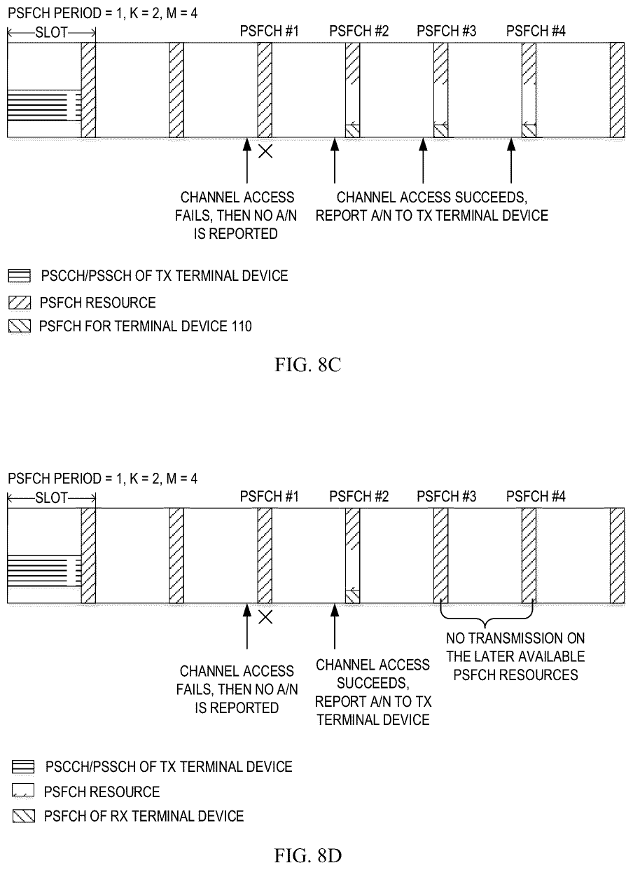

As mentioned above, according to the first scheme, the NACK feedback can be transmitted on all the available PSFCH resource. For example, FIG. 8C illustrates an example of timing line between a sidelink data transmission on PSSCH and a PSFCH resource. In the example of FIG. 8C, the PSFCH period=1, K=2, M=4. The terminal device 110-1 may have maximum 4 opportunities to transmit HARQ feedback information. The maximum 4 opportunities comprise PSFCH #1, PSFCH #2, PSFCH #3 and PSFCH #4. Because a channel access procedure of the terminal device 110 fails on PSFCH #1, the terminal device 110-1 does not transmit HARQ feedback information. After a success of channel access procedure, the terminal device 110-1 transmits the HARQ feedback information on each of PSFCH #2, PSFCH #3 and PSFCH #4. In other words, the terminal device 110-1 may try to transmit the HARQ feedback information on all the available PSFCH resource. It should be noted that the terminal device 110-1 may perform a channel access procedure on each of PSFCH #2, PSFCH #3 and PSFCH #4 or only on PSFCH #2. In some embodiments, the terminal device 110-1 may transmit the HARQ feedback information on a starting feedback channel resource among the third number of feedback channel resources after a success of channel access procedure. Such embodiments can reduce unnecessary retransmission of HARQ feedback information. This will be described with reference to FIG. 8D.

Alternatively, according to the second scheme, once A/N is reported, the Rx terminal device may not transmit on the remaining available PSFCH resources. For example, FIG. 8D illustrates an example of timing line between a sidelink data transmission on PSSCH and a PSFCH resource. In the example of FIG. 8D, the PSFCH period=1, K=2, M=4. The terminal device 110-1 may have maximum 4 opportunities to transmit HARQ feedback information. The maximum 4 opportunities comprise PSFCH #1, PSFCH #2, PSFCH #3 and PSFCH #4. Because a channel access procedure of the terminal device 110-1 fails on PSFCH #1, the terminal device 110-1 does not transmit HARQ feedback information. After a success of channel access procedure, the terminal device 110-1 transmits HARQ feedback information on a starting PSFCH resource, i.e., PSFCH #2. The terminal device 110-1 does not transmit HARQ feedback information on the later available PSFCH #3 and PSFCH #4.

According to embodiments of FIG. 3, if one sidelink transmission is associated with a plurality of sidelink feedback reception occasions, the terminal device needs to monitor the last set of sidelink feedback reception occasions. The terminal device also generates the ACK/NACK for the sidelink transmissions based on the PSFCH receptions on the last set of sidelink feedback reception occasions, and reports the HARQ feedback information to the base station by considering the LBT failure information, usage of multiple PSFCH resources, and the gap between PSFCH and PUCCH/PUSCH, which will remove the error case for reporting SL HARQ-ACK in PUCCH/PUSCH when multiple PSFCHs are associated with one PSSCH transmission.

Some embodiments regarding how to allocate PSFCH resources (such as, in unlicensed bands) are described in the following description.

In some embodiments, the terminal device 110-1 may determine a third number of feedback channel resources. The third number of the feedback channel resources is for HARQ feedback information associated with a sidelink data transmission with a sub-channel in a slot. Each of the third number of the feedback channel resources comprises a fourth number of consecutive symbols in a slot and a fifth number of RBs.

In some embodiments, the HARQ feedback information may comprise positive acknowledgement (ACK or A) or negative acknowledgement (NACK or N). Thus, hereinafter, the HARQ feedback information is also referred to as A/N for short.

In some embodiments, the terminal device 110-1 may transmit the HARQ feedback information on at least one of the first number of the feedback channel resources.

In some embodiments, the terminal device 110-1 may determine the third number of feedback channel resources based on at least one of the following: a pre-configuration, or a configuration.

In some embodiments, the third number may be configured or pre-configured by a network node device, such as the network device 120 as shown in FIG. 2. In some embodiments, the third number may be configured or pre-configured by using RRC signaling, such as System Information Block (SIB) message, RRCReconfiguration message and so on.

In some embodiments, the terminal device 110-1 may determine the third number of feedback channel resources for at least one of the following: a sidelink resource pool, a Bandwidth Part (BWP), an RB set, or a carrier.

In embodiments where the third number is configured per sidelink resource pool, terminal devices working in the sidelink resource pool should have a common understanding of candidate PSFCH resources and avoid resource conflict among sidelink transmissions.

In embodiments where the third number is configured per BWP, RB set or carrier, an additional benefit can be obtained. That is, terminal devices working on the BWP, RB set or carrier should have a common Tx/Rx switching GP and avoid sidelink signal receiving loss based on the GP.

In some embodiments, the fourth number may be equal to or larger than three.

In some embodiments, the terminal device 110-1 may determine the fifth number based on at least one of the following:
the third number;
the fourth number;
the number of RBs in a resource pool used for feedback channel resources;
the number of slots in the resource pool used for the feedback channel resources;
the number of sub-channels in the resource pool;
a period of the feedback channel resources;
the number of slots in the resource pool; or
the number of interlaces in the resource pool.

In some embodiments, the terminal device 110-1 may determine the fifth number as the number of RBs in a resource pool configured for feedback channel resources divided by a product of the third number, the number of sub-channels in the resource pool and the period of the feedback channel resources. For example, the terminal device 110-1 may determine the fifth number based on the following:

$${M}_{PRB , slot}^{PSFCH} = {M}_{PRB , set}^{PSFCH} / ( M * {N}_{subch} * {N}_{PSSCH}^{PSFCH} ) \qquad ( 2 )$$

where M_{PRB,slot}^{PSFCH} represents the fifth number, M_{PRB,set}^{PSFCH} represents the number of RBs in a resource pool used for feedback channel resources, M represents the first number, N_{subch} represents the number of sub-channels in the resource pool, and N_{PSSCH}^{PSFCH} represents the period of the feedback channel resources.

Alternatively, the terminal device 110-1 may determine the fifth number by rounding down the number of RBs in the resource pool configured for the feedback channel resources divided by the product of the first number, the number of sub-channels in the resource pool and the period of the feedback channel resources. For example, the terminal device 110-1 may determine the fifth number based on the following:

$${M}_{PRB , slot}^{PSFCH} = {M}_{PRB , set}^{PSFCH} / ( M * {N}_{subch} * {N}_{PSSCH}^{PSFCH} ) \qquad ( 3 )$$

In some embodiments, in order to satisfy the requirement of occupied channel bandwidth (OCB), interlace based RB allocation may be used in unlicensed band. Several non-consecutive PRBs may be assigned as resources of each interlace.

In some embodiments, the number of interlaces in the resource pool may be equal to the number of sub-channels in the resource pool. In such embodiments, the terminal device 110-1 may determine the fifth number as the number of RBs in a resource pool configured for feedback channel resources divided by a product of the first number, the number of interlaces in the resource pool and the period of the feedback channel resources. Alternatively, the terminal device 110-1 may determine the fifth number by rounding down the number of RBs in the resource pool configured for the feedback channel resources divided by the product of the third number, the number of interlaces in the resource pool and the period of the feedback channel resources.

In embodiments where interlace based RB allocation is used, the number of sub-channels in the resource pool may be determined based on the number of interlaces in the resource pool. For example, the number of sub-channels in the resource pool may be determined based on the following:

$${N}_{subch} = f ( {N}_{interlace} ) \qquad ( 4 )$$

where N_{interlace} represents the number of interlaces in the resource pool. In such embodiments, the terminal device 110-1 may determine the number of sub-channels in the resource pool based on the Equation (4). In turn, the terminal device 110-1 may determine the fifth number based on the Equation (2) or the Equation (3).

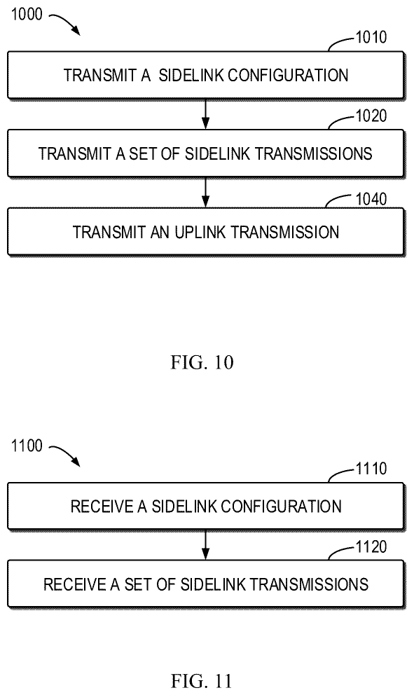

In some embodiments, the M PSFCH resources are allocated in M logical consecutive slots which contain PSFCH resources, i.e., one PSFCH resource in each slot. It provides multiple transmission opportunities for the terminal device 110-1 to transmit HARQ feedback information on sidelink, which may avoid unnecessary retransmission and improve the transmission performance. This will be described with reference to FIGS. 10A to 10E.

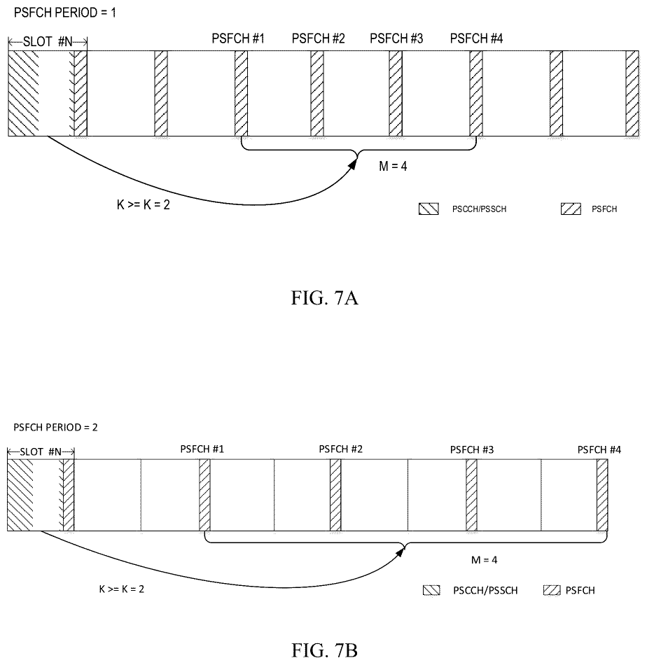

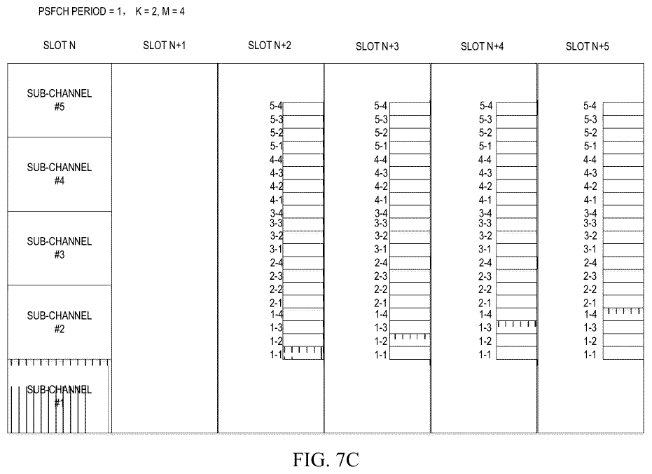

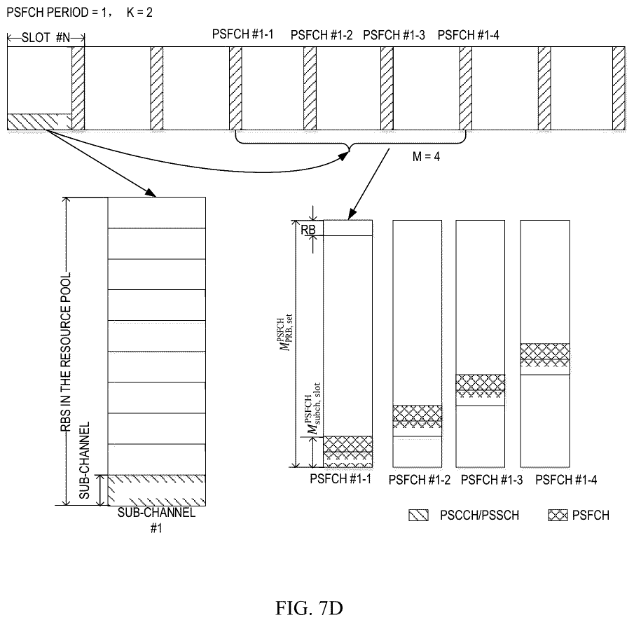

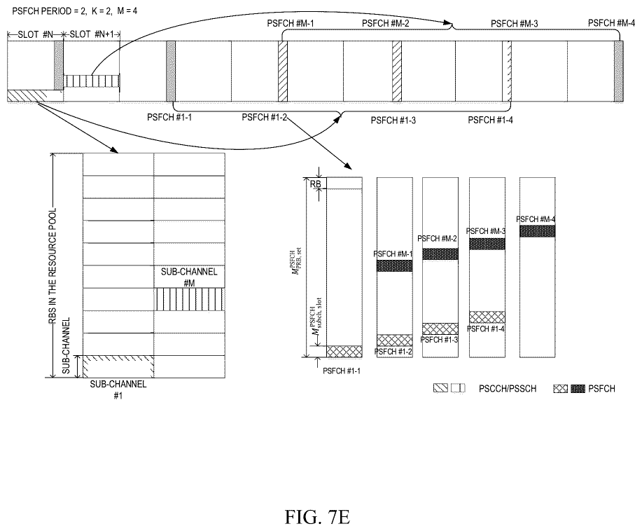

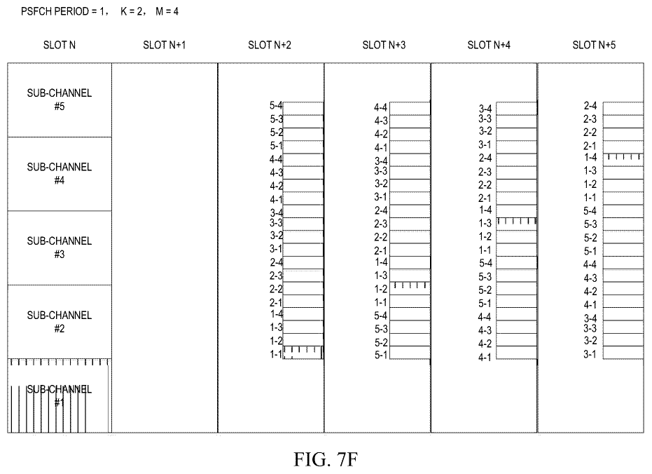

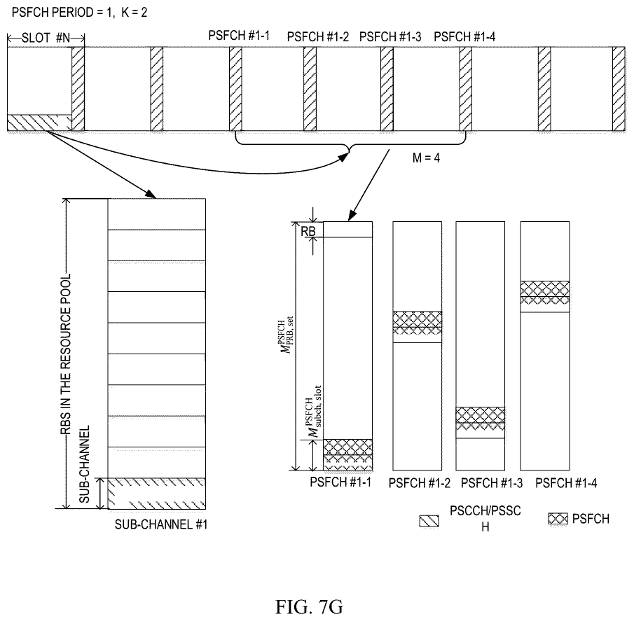

In the examples of FIGS. 7A to 7E, each of the third number of the feedback channel resources comprises symbols that are different from each other. The third number of the feedback channel resources comprises logical consecutive symbols which are used for feedback channel resources.

FIGS. 7A and 7B illustrate an example of timing line between a sidelink data transmission on PSSCH and a PSFCH resource, respectively.

In the example of FIG. 7A, the PSFCH period=1, K=2 and M=4. HARQ feedback information associated with a data transmission on PSSCH in slot #n may be transmitted on at least one of PSFCH resources #1, #2, #3, #4.

In the example of FIG. 7B, the PSFCH period=2, K=2 and M=4. HARQ feedback information associated with a data transmission on PSSCH in slot #n may be transmitted on at least one of PSFCH resources #1, #2, #3, #4.

Compared with legacy one-to-one PSSCH and corresponding PSFCH resource mapping, 1-to-M mapping scheme provides more transmission opportunities for sidelink HARQ feedback transmission.

FIGS. 7C, 7D and 7E illustrate an example of mapping between a sidelink data transmission on PSSCH and PSFCH resources, respectively.

In the examples of FIGS. 7C, 7D and 7E, the terminal device 110-1 may determine the same RBs for each of the third number of the feedback channel resources. In other words, the M times transmission opportunities for HARQ feedback information associated with a sidelink data transmission with a sub-channel in a slot are allocated on the same RB(s) in each PSFCH resource.

In the example of FIG. 7C, the PSFCH period N_{PSSCH}^{PSFCH}=1, K=2 and M=4. HARQ feedback information associated with a sidelink data transmission with sub-channel #1 in slot #n may be transmitted on at least one of four PSFCH resources in slots n+2, n+3, n+4 and n+5, respectively. Each of the four PSFCH resources comprises 1 RB.

In the example of FIG. 7D, there are M_{PRB,set}^{PSFCH}=100 RBs used for PSFCH, and the number of sub-channels N_{subch}=10, the PSFCH period N_{PSSCH}^{PSFCH}=1, M=4, and K=2. HARQ feedback information associated with a sidelink data transmission with sub-channel #1 in slot #n may be transmitted on at least one of four PSFCH resources PSFCH #1-1, PSFCH #1-2, PSFCH #1-3, PSFCH #1-4, respectively. All the RBs for PSFCH are divided into M*N_{subch}*N_{PSSCH}^{PSFCH}=80 sets, and each set comprises M_{PRB,slot}^{PSFCH}=└M_{PRB,set}^{PSFCH}/(M*N_{subch}*N_{PSSCH}^{PSFCH})┘=2 RBs.

In the example of FIG. 7E, there are M_{PRB,set}^{PSFCH}=80 RBs used for PSFCH, and the number of sub-channels N_{subch}=10, the PSFCH period N_{PSSCH}^{PSFCH}=2, M=4 and K=2. HARQ feedback information associated with a sidelink data transmission with sub-channel #1 in slot #n may be transmitted on at least one of four PSFCH resources PSFCH #1-1, PSFCH #1-2, PSFCH #1-3, PSFCH #1-4, respectively. HARQ feedback information associated with a sidelink data transmission with sub-channel #m in slot #n+1 may be transmitted on at least one of four PSFCH resources PSFCH #m−1, PSFCH #m−2, PSFCH #m−3, PSFCH #m−4, respectively. All the RBs for PSFCH are divided into M*N_{subch}*N_{PSSCH}^{PSFCH}=80 sets, and each set comprises M_{PRB,slot}^{PSFCH}=M_{PRB,set}^{PSFCH}/(M*N_{subch}*N_{PSSCH}^{PSFCH}),=1 RB.

In some embodiments, the terminal device 110-1 may determine the fifth number of RBs for each of the first number of the feedback channel resources based on frequency hopping indication. When the frequency hopping indication is assigned as disable, the terminal device 110-1 may determine PSFCH resources according to the embodiments as shown in FIGS. 7A to 7E. When the frequency hopping indication is assigned as enable, the terminal device 110-1 may determine PSFCH resources according to the embodiments as shown in FIGS. 7F and 7G. Such embodiments further provide frequency diversity gain.

In such embodiments, the terminal device 110-1 may determine the frequency hopping indication based on at least one of the following: a pre-configuration, or a configuration. The terminal device 110-1 may determine the frequency hopping indication for at least one of the following: a sidelink resource pool, a BWP, an RB set, or a carrier.

FIGS. 7F and 7G illustrate an example of mapping between a sidelink data transmission on PSSCH and PSFCH resources, respectively. In the examples of FIGS. 7F and 7G, the frequency hopping indication is assigned as enable. Thus, the terminal device 110-1 may determine different RBs for each of four feedback channel resources in slots n+2, n+3, n+4 and n+5. In turn, the terminal device 110-1 may transmit HARQ feedback information on the corresponding PSFCH resources.

In some embodiments, the terminal device 110-1 may determine a sixth number of feedback channel resources based on configuration information. The sixth number of feedback channel resources comprises a subset of the third number of feedback channel resources. In turn, the terminal device 110-1 may transmit the HARQ feedback information on at least one of the sixth number of feedback channel resources. In such embodiments, the terminal device 110-1 may receive the configuration information from a communication device. The communication device may be at least one of following: a network node device (such as the network device 120), a control node device, or a sidelink terminal device. In such embodiments, the communication device may determine the fourth number based on latency requirement of HARQ feedback. This will be described with reference to FIG. 8A.

FIG. 8A illustrates an example of timing line between a sidelink data transmission on PSSCH and a PSFCH resource. In the example of FIG. 8A, according to the resource pool configuration with M=4, the terminal device 110-1 may have maximum 4 opportunities to transmit its HARQ feedback information to Tx terminal device.

On the other hand, the allowed latency of receiving HARQ feedback information from the terminal device 110 is less than a duration of M₀ PSFCH resources. For this case, Tx terminal device may further indicate M₀ to the terminal device 110-1 to limit the feedback with the earliest M₀ PSFCH resources configured in the resource pool.

In such embodiments, the terminal device 110-1 may be one of the following: a terminal device paired for sidelink unicast communication with the communication device, or a member terminal device in a same sidelink communication group with the communication device. In such embodiments, the communication device may determine the sixth number based on latency requirement of HARQ feedback. In this way, the communication device transmitting the sidelink data transmission can further control and assign the available PSFCH resources for the sidelink data transmission.

In such embodiments, the terminal device 110-1 may receive the configuration information via one of the following: a PC5 radio resource control (RRC) signaling, or sidelink control information.

In some embodiments, the terminal device 110-1 may determine a timing interval based on configuration information. The timing interval starts from the sidelink data transmission. For example, the timing interval may use slot or millisecond (ms) as a time unit. In turn, the terminal device 110-1 may transmit the HARQ feedback information on the at least one of the first number of the feedback channel resources which are within the timing interval. In such embodiments, the terminal device 110-1 may receive the configuration information from a communication device. The communication device may be at least one of following: a network node device, a control node device, or a sidelink terminal device. In such embodiments, the communication device may determine the fourth number based on latency requirement of HARQ feedback. In this way, the communication device can further control and assign the available PSFCH resources for the sidelink data transmission. This will be described with reference to FIG. 8B.

FIG. 8B illustrates an example of timing line between a sidelink data transmission on PSSCH and a PSFCH resource. In the example of FIG. 8B, according to the resource pool configuration with M=2, the terminal device 110-1 may have maximum 2 opportunities to transmit its HARQ feedback information to Tx terminal device. On the other hand, the allowed latency of receiving HARQ feedback information from the terminal device 110-1 is T₀=6 slots which is assigned by Tx UE. For this case, the terminal device 110-1 may transmit HARQ feedback information for PSSCH transmission #1 using PSFCH resource #1 while PSFCH resource #2 is out of the duration of T₀. For the PSSCH transmission #2, with the same T₀, the terminal device 110-1 may use PSFCH resources #1 and #2 for transmission of HARQ feedback information.

In such embodiments, the terminal device 110-1 may be one of the following: a terminal device paired for sidelink unicast communication with the communication device, or a member terminal device in a same sidelink communication group with the communication device.

In such embodiments, the terminal device 110-1 may receive the configuration information via one of the following: a PC5 radio resource control (RRC) signaling, or sidelink control information.

In some embodiments, the terminal device 110-1 may transmit the HARQ feedback information on each of the feedback channel resources after a success of channel access procedure. In other words, the terminal device 110-1 may try to transmit the HARQ feedback information on all the available PSFCH resource. Such embodiments can improve the performance of HARQ feedback receiving and further benefit sidelink transmission efficiency. This will be described with reference to FIG. 11C.

FIG. 8C illustrates an example of timing line between a sidelink data transmission on PSSCH and a PSFCH resource and FIG. 8D illustrates an example of timing line between a sidelink data transmission on PSSCH and a PSFCH resource, which have been described above.

In some embodiments, the first number of feedback channel resources may comprise a plurality of feedback channel resources in a slot. In such embodiments, the plurality of feedback channel resources may be allocated in consecutive symbols in the slot.

In some embodiments, the terminal device 110-1 may determine the first number of feedback channel resources based on at least one of the following: a first type of configuration, or a second type of configuration.

In some embodiments, each of the first type of configuration and the second type of configuration indicates at least one of the following:
a period of the feedback channel resources,
the number of symbols used for the feedback channel in a slot,
an allocation of symbols used for the feedback channel in a slot,
the number of RBs used for the feedback channel in a resource pool,
an allocation of RBs used for the feedback channel in a resource pool, or
a slot offset of the period of the feedback channel resources.

Hereinafter, the first type of configuration is also referred to as legacy PSFCH configuration or type 1 configuration, and the second type of configuration is also referred to as additional configuration or type 2 configuration. The second type of configuration should be allocated on symbols which are not used for the first type of configuration. In some embodiments, the second type of configuration may be independent from the first type of configuration. If the first type of configuration and the second type of configuration are in the same slot, the symbols used for subset should be consecutive. Within a slot, one or more subsets may be assigned by the second type of configuration. Such embodiments may provide more configuration flexibility for PSFCH resource allocation.

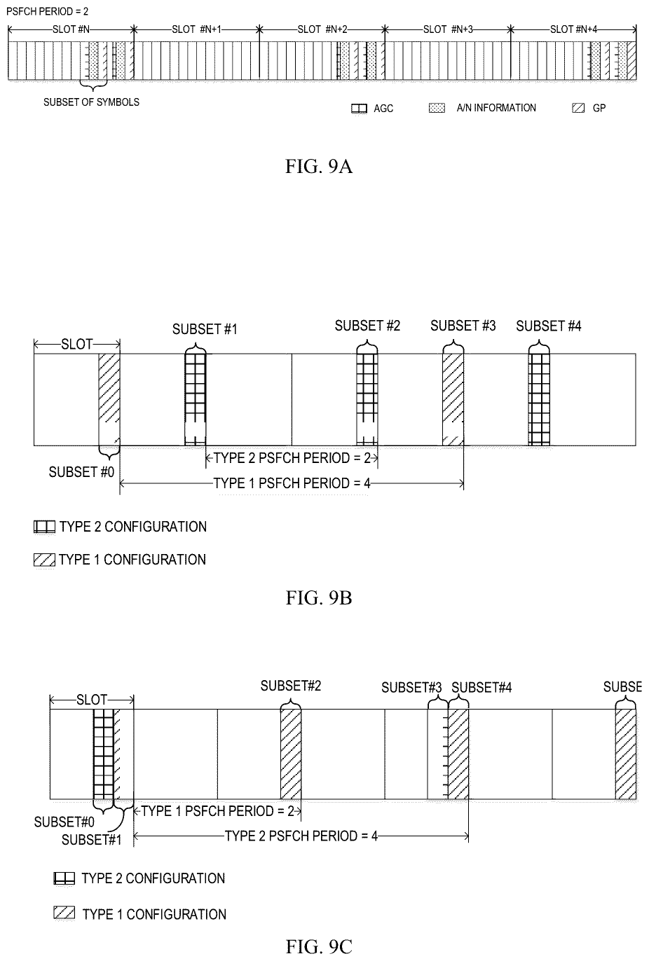

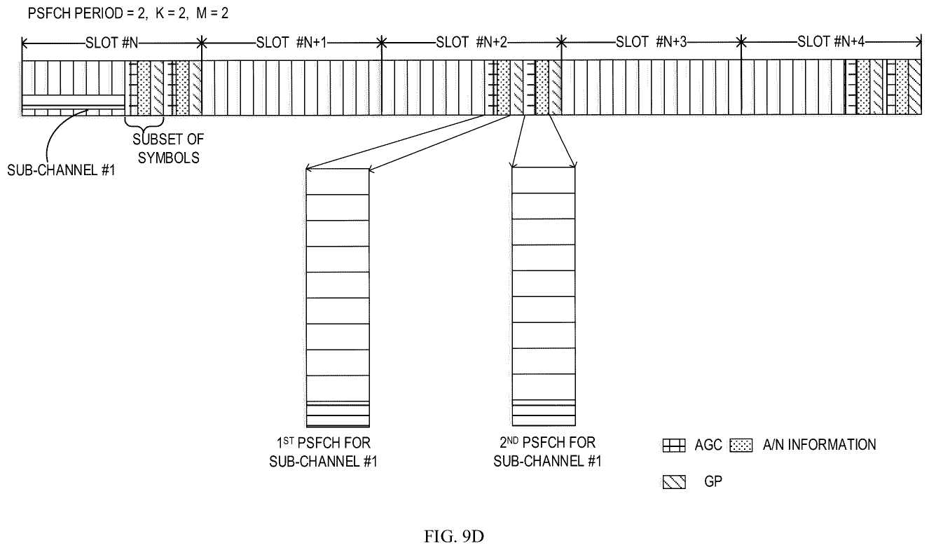

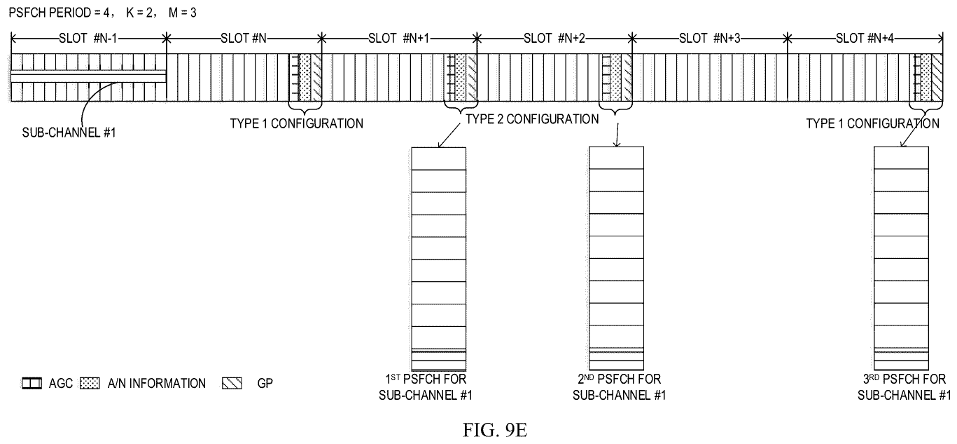

Such embodiments will be described with reference to FIGS. 9A to 9E.

FIGS. 9A to 9E illustrate an example of PSFCH resource allocation, respectively. In the examples of FIGS. 9A to 9E, each of the third number of the feedback channel resources comprises the fourth number of consecutive symbols, and the fourth number is equal to three. In time domain, every three consecutive symbols are used as one subset, which comprises AGC symbol, information symbol and GP symbol. One subset of symbols is used as a unit for PSFCH resource allocation in time domain. One subset corresponds to one A/N transmission occupancy in time domain. One subset comprises several PSFCH resources with different RB(s).

In the example of FIG. 9A, within a slot, two subsets are allocated as PSFCH resources. The two subsets use consecutive symbols. For each slot which comprises PSFCH resource, the number and allocation of subsets are the same. This example may provide more resources for PSFCH, and may be combined with 1-to-M mapping scheme to improve sidelink A/N reporting performance.

In the example of FIG. 9B, the terminal device 110-1 determines the first number of feedback channel resources based on the first type of configuration and the second type of configuration. The PSFCH period for the first type of configuration is 4, and the PSFCH period for the second type of configuration is 2. The terminal device 110-1 determines subsets #0 and #3 for PSFCH resources based on the first type of configuration. The terminal device 110-1 determines subsets #1 and #2 for PSFCH resources based on the second type of configuration. Each of the subsets comprises three or more consecutive symbols.

In the example of FIG. 9C, the terminal device 110-1 determines the first number of feedback channel resources based on the first type of configuration and the second type of configuration. The PSFCH period for the first type of configuration is 2, and the PSFCH period for the second type of configuration is 4. The terminal device 110-1 determines subsets #1, #2, #4 and #5 for PSFCH resources based on the first type of configuration. The terminal device 110 determines subsets #0 and #3 for PSFCH resources based on the second type of configuration. Each of the subsets comprises three or more consecutive symbols.

The example of FIG. 9D may be considered as a combination of the example of FIG. 9A with any of examples of FIGS. 7A to 7G. In the example of FIG. 9D, the PSFCH period=2, K=2 and M=2. Two subsets of symbols are configured in each slot which comprises PSFCH resources. The two subsets use consecutive symbols. The same PSFCH allocation is used for each subset in a slot, i.e., the PSFCH allocation of the last three symbols is repeated to the prior subset. Each subset comprises one PSFCH resource for a corresponding PSSCH transmission. For a sidelink data transmission with sub-channel #1 in slot #n, the terminal device 110-1 may transmit HARQ feedback information on at least one of a first PSFCH resource for sub-channel #1 and a second PSFCH resource for sub-channel #1.

The example of FIG. 9E may be considered as a combination of the example of FIG. 9B or FIG. 9C with any of examples of FIGS. 7A to 7G. In the example of FIG. 9E, the PSFCH period=4, K=2 and M=3.

For a sidelink data transmission with sub-channel #1 in slot #n−1, the terminal device 110-1 determines, based on the second type of configuration, a first PSFCH resource in slot #n+1 for sub-channel #1 and a second PSFCH resource in slot #n+2 for sub-channel #1. In addition, for the sidelink data transmission with sub-channel #1 in slot #n−1, the terminal device 110 also determines, based on the first type of configuration, a third PSFCH resource in slot #n+4 for sub-channel #1. In other words, for the sidelink data transmission, logical consecutive three slots which contains PSFCH resources are used as multiple transmission opportunities for HARQ feedback information.

In each of slots #n+1, #n+2 and #n+4, there is one subset of consecutive symbols, i.e. the last three symbols in each of the slots are used for transmission of HARQ feedback information.

FIG. 10 shows a flowchart of an example method 1000 in accordance with an embodiment of the present disclosure. The method 1000 can be implemented at any suitable devices. Only for the purpose of illustrations, the method 1000 can be implemented at a terminal device 110-1 as shown in FIG. 2.

In some embodiments, the terminal device 110-1 may receive a resource configuration of sidelink transmissions from the network device 120. In some embodiments, the resource configuration may indicate a resource pool allocated for the sidelink transmissions.

In some embodiments, the resource configuration may comprise parameters which are used to manage resource selection. For example, the resource configuration may indicate resources for PSCCH value, for example, PSCCH subframes and resource blocks. Alternatively or in addition, the resource configuration may comprise a time resource pattern index which indicates PSSCH subframes. In some other embodiments, the resource configuration may comprise resource allocation parameters which indicate PSSCH resource blocks.

In some embodiments, the resource configuration can indicate the first number of sidelink feedback reception occasions in a set of sidelink feedback reception occasions. In other words, the resource configuration may indicate that one sidelink transmission can correspond to the first number of sidelink feedback reception occasions. For example, if the first number is M, it means that one sidelink transmission is associated with M sidelink feedback reception occasions.

In some embodiments, the first number of sidelink feedback reception occasions can be configured per carrier. Alternatively, the first number of sidelink feedback reception occasions can be configured per bandwidth part (BWP). In some other embodiments, the first number of sidelink feedback reception occasions can be configured per resource pool. Alternatively, the first number of sidelink feedback reception occasions can be predefined at the terminal device 110-1.

Alternatively, the terminal device 110-1 may determine the second number of sidelink feedback reception occasions in the set of sidelink feedback reception occasions. For example, the terminal device 110-1 may determine the second number of sidelink feedback reception occasions based on a traffic packet delay budget (PDB). The Packet Delay Budget can be described as an upper bound for the time that a packet may be delayed between the UE and the PCEF (Policy and Charging Enforcement Function). In this case, if the PDB is increased, the second number can be decreased. In other words, the larger PDB can be with the smaller second number.

In other embodiments, the terminal device 110-1 may determine the second number of sidelink feedback reception occasions based on a priority of the set of sidelink transmissions. In this case, if the set of sidelink transmissions has a higher priority, the second number of sidelink feedback reception occasions can be larger. In other words, the higher priority can be with the larger second number.

At block 1010, the terminal device 110-1 transmits a sidelink configuration to the terminal device 110-2. The sidelink configuration also indicates that a sidelink feedback type for the sidelink transmission is negative acknowledgement only (NACK-only).

The sidelink configuration indicates that one sidelink transmission corresponds to one set of sidelink feedback reception occasions. In some embodiments, the sidelink configuration can indicate the first number of sidelink feedback reception occasions in the set of sidelink feedback reception occasions. As mentioned above, the terminal device 110-1 may determine the second number of sidelink feedback reception occasions. In this case, the sidelink configuration can indicate the second number of sidelink feedback reception occasions in the set of sidelink feedback reception occasions. For example, the sidelink configuration can indicate that there are M sidelink feedback reception occasions in the set of sidelink feedback reception occasions.

At block 1020, the terminal device 110-1 transmits a set of sidelink transmissions to the set of terminal devices.

In some embodiments, a time gap between two adjacent sidelink transmissions in the set of sidelink transmissions can comprise: a first time gap between an end of a last symbol of a first sidelink transmission of the set of sidelink transmissions and a start of a first symbol of a starting sidelink feedback reception in the set of sidelink feedback reception occasions, a second time gap between a first symbol of the starting sidelink feedback reception occasion and a first symbol of the last sidelink feedback reception occasion in the set of sidelink feedback reception occasions, and a third time gap required for the last sidelink feedback reception and processing plus sidelink retransmission preparation.

In some embodiments, the time gap between the start of a PSCCH/PSSCH slot and the start symbol of the last PSFCH associated with a preceding PSCCH/PSSCH slot in the same CG or in the set of resources indicated by one DCI should be larger than a predefined duration T_m. T_m can comprise PSFCH reception and processing plus sidelink retransmission preparation including multiplexing of necessary physical channels and any TX-RX/RX-TX switching time.

As mentioned above, the sidelink configuration indicates that the sidelink feedback type is NACK only. In this case, if the terminal device 110-2 cannot decode or receive the sidelink transmission from the terminal device 110-1, the terminal device 110-2 may transmit 3050 a NACK. Alternatively, if the terminal device 110-2 successfully decodes or receives the sidelink transmission from the terminal device 110-1, the terminal device 110-2 may not transmit any feedback to the terminal device 110-1.

In some embodiments, the terminal device 110-1 may monitor sidelink feedbacks for the set of sidelink transmissions on a plurality of sets of sidelink feedback reception occasions.

At block 1040, the terminal device 110-1 transmits an uplink transmission to the network device 120. The uplink transmission indicates an ACK or NACK for the set of sidelink transmissions. In some embodiments, the uplink transmission can be transmitted within a slot with a slot offset. In this case, the slot can be the slot of a starting sidelink feedback reception occasion in the last set of sidelink feedback reception occasions and the slot offset can be larger than the number of slots which are occupied by the last set of sidelink feedback reception occasions. In other words, with reference to slots for PUCCH transmissions and for a number of PSFCH reception occasions, the terminal device 110-1 can provide the generated HARQ-ACK information in a PUCCH transmission within slot n+k, where slot n is the slot of the first PSFCH reception occasion associated with the last PSCCH/PSSCH resource of the set of resources indicated in a dynamic grant or configured grant where k is a number of slots indicated by a PSFCH-to-HARQ_feedback timing indicator field, if present, in a DCI format indicating a slot for PUCCH transmission to report the HARQ-ACK information, or k is provided by sl-PSFCH-ToPUCCH for a transmission scheduled by a DCI format or for a SL configured grant type 2, or by sl-PSFCH-ToPUCCH-CG-Type1 for a SL configured grant type 1. k=0 corresponds to a last slot for a PUCCH transmission that would overlap with the last PSFCH reception occasion assuming that the start of the sidelink frame is same as the start of the downlink frame.

If no sidelink feedback is received on the last set of sidelink feedback reception occasions of the plurality of sidelink feedback reception occasions, the terminal device 110-1 transmits the uplink transmission indicating an acknowledgement for the set of sidelink transmissions.

Alternatively, in some embodiments, if at least one sidelink feedback is received on the last set of sidelink feedback reception occasions of the plurality of sidelink feedback reception occasions, the terminal device 110-1 transmits the uplink transmission indicating a NACK for the set of sidelink transmissions.

As mentioned above, the terminal device 110-2 may transmit the indication of the LBT failure. In this case, in some embodiments, the terminal device 110-1 may transmit the uplink transmission indicating the NACK for the set of sidelink transmissions. Alternatively, the uplink transmission may indicate HARQ-ACK information which is preconfigured by the network device 120. In other words, for reporting HARQ-ACK information on uplink corresponding to one or multiple PSSCH transmissions, the terminal device 110-1 may generate HARQ-ACK information with the contents instructed by higher layer, if the terminal device 110-1 is informed of contiguous LBT/access failure of the associated receiver terminal devices. The priority value of the HARQ-ACK information can be same as the priority value of the PSSCH transmission. In some other embodiments, the terminal device 110-1 may generate a NACK when the terminal device 110-1 does not receive PSFCH in any PSFCH reception occasion associated with a PSSCH transmission in a resource provided by a DCI format 3_0 or, for a configured grant, in a resource provided in a single period and for which the terminal device 110-1 is provided a PUCCH resource to report HARQ-ACK information and is informed of contiguous LBT/access failure of the associated receiver terminal devices. The priority value of the NACK is same as the priority value of the PSSCH transmission.

As mentioned above, the sidelink configuration may indicate a scheme for reporting ACK/NACK on multiple resources. If NACK only is selected and multiple PSFCH reception/transmission occasions are associated with one PSSCH transmission/reception, the first scheme where the NACK feedback is transmit on all the available PSFCH resource can be selected. In this case, the sidelink configuration may indicate the first scheme. In other words, if the first scheme is selected/enabled, the terminal device 110-1 can select positive-negative acknowledgement or negative-only acknowledgement. Alternatively, if positive-negative acknowledgement is selected and multiple PSFCH reception/transmission occasions are associated with one PSSCH transmission/reception, either the first scheme or the second scheme where once A/N is reported the Rx terminal device should not transmit on the remaining available PSFCH resources can be selected. In other words, if the second scheme is selected/enabled, the terminal device 110-1 can select positive-negative acknowledgement. In some embodiments, the first scheme or the second scheme can be configured by the network device 120.

FIG. 11 shows a flowchart of an example method 1100 in accordance with an embodiment of the present disclosure. The method 1100 can be implemented at any suitable devices. Only for the purpose of illustrations, the method 1100 can be implemented at a terminal device 110-2 as shown in FIG. 2.

At block 1110, the terminal device 110-2 receives a sidelink configuration from the terminal device 110-1. The sidelink configuration also indicates that a sidelink feedback type for the sidelink transmission is negative acknowledgement only (NACK-only).

The sidelink configuration indicates that one sidelink transmission corresponds to one set of sidelink feedback reception occasions. In some embodiments, the sidelink configuration can indicate the first number of sidelink feedback reception occasions in the set of sidelink feedback reception occasions. As mentioned above, the terminal device 110-1 may determine the second number of sidelink feedback reception occasions. In this case, the sidelink configuration can indicate the second number of sidelink feedback reception occasions in the set of sidelink feedback reception occasions. For example, the sidelink configuration can indicate that there are M sidelink feedback reception occasions in the set of sidelink feedback reception occasions.

At block 1120, the terminal device 110-2 receives a set of sidelink transmissions from the terminal device 110-1. In some embodiments, a time gap between two adjacent sidelink transmissions in the set of sidelink transmissions can comprise: a first time gap between an end of a last symbol of a first sidelink transmission of the set of sidelink transmissions and a start of a first symbol of a first sidelink feedback reception in the set of sidelink feedback reception occasions, a second time gap between a first symbol of the first sidelink feedback reception occasion and a first symbol of the last sidelink feedback reception occasion in the set of sidelink feedback reception occasions, and a third time gap required for the last sidelink feedback reception and processing plus sidelink retransmission preparation.

In some embodiments, the time gap between the start of a PSCCH/PSSCH slot and the start symbol of the last PSFCH associated with a preceding PSCCH/PSSCH slot in the same CG or in the set of resources indicated by one DCI should be larger than a predefined duration T_m. T_m can comprise PSFCH reception and processing plus sidelink retransmission preparation including multiplexing of necessary physical channels and any TX-RX/RX-TX switching time.

As mentioned above, the sidelink configuration indicates that the sidelink feedback type is NACK only. In this case, if the terminal device 110-2 cannot decode or receive the sidelink transmission from the terminal device 110-1, the terminal device 110-2 may transmit a NACK. Alternatively, if the terminal device 110-2 successfully decodes or receives the sidelink transmission from the terminal device 110-1, the terminal device 110-2 may not transmit any feedback to the terminal device 110-1.

In some embodiments, the sidelink configuration may further indicate a scheme for reporting ACK/NACK on multiple resources. For example, the sidelink configuration may indicate that a sidelink feedback for the sidelink transmission needs to be transmitted on each of the set of sidelink feedback reception occasions.

In some embodiments, the terminal device 110-2 may perform a listen-before-talk or a clear channel assessment (CCA) before the transmission of the NACK. The term “listen-before-talk (LBT)” used herein can refer to a technique used in radio communications whereby a radio transmitter senses its radio environment before it starts a transmission. LBT can be used by a radio device to find a network the device is allowed to operate on or to find a free radio channel to operate on. The term “clear channel assessment (CCA)” used herein refers to a technique to appraise the RF medium. The CCA may involve listening for RF transmissions at the Physical layer radios use a CCA threshold when listening to the RF medium. For example, energy detection may be used in the CCA. The energy detection (ED) threshold is used to detect any other type of RF transmissions during the CCA. If energy detected on the channel is less than an energy detection threshold, the channel can be regarded as available for performing transmissions. If the energy detected on the channel is larger than an energy detection threshold, the channel can be regarded as busy. For example, the terminal device 110-2 may determine a result of the LBT (or CCA) on the unlicensed spectrum band based on a difference between the energy of the sidelink transmission on the unlicensed spectrum band and a measured energy of the LBT (or CCA). For example, if the difference is within a threshold difference, the LBT may be considered as successfully to acquire the COT by the terminal device 310-1. In other words, if the energy detection in the LBT is similar as the calculated energy level of monitored SL-U transmission, the LBT may be considered as successfully to acquire the COT by COT initiating device. Alternatively, if the energy detection in the LBT is higher than the calculated energy level of monitored SL-U transmission beyond the configured threshold, the LBT may be considered as a failure.

If the LBT is successful, the terminal device 110-2 may transmit the NACK to the terminal device 110-1. Alternatively, if the LBT is failed, the terminal device 110-2 may transmit an indication of the LBT failure to the terminal device 110-1. For example, in some embodiments, the terminal device 110-2 may transmit SCI indicating the LBT failure to the terminal device 110-1. In some other embodiments, the terminal device 110-2 may transmit a PSSCH or PSCCH indicating the LBT failure to the terminal device 110-1. Alternatively, the terminal device 110-2 may transmit a medium access control (MAC) control element (CE) indicating the LBT failure to the terminal device 110-1. In other embodiments, the terminal device 110-2 may transmit a PC5-radio resource control (RRC) signaling indicating the LBT failure to the terminal device 110-1.

In some embodiments, a terminal device comprises circuitry configured to transmit, to a set of terminal devices, a sidelink configuration, wherein the sidelink configuration indicates that one sidelink transmission corresponds to one set of sidelink feedback reception occasions and the sidelink configuration also indicates that a sidelink feedback type for the sidelink transmission is negative acknowledgement only (NACK-only); transmit a set of sidelink transmissions to the set of terminal devices; and in accordance with a determination that no sidelink feedback is received on the last set of sidelink feedback reception occasions in a plurality of sets of sidelink feedback reception occasions associated with the set of sidelink transmissions, transmit, to a network device, an uplink transmission indicating an acknowledgement for the set of sidelink transmissions.

In some embodiments, the terminal device comprises circuitry configured to in accordance with a determination that at least one sidelink feedback is received on the last set of sidelink feedback reception occasions, transmit, to the network device, the uplink transmission indicating a NACK for the set of sidelink transmissions.

In some embodiments, the terminal device comprises circuitry configured to receive, at the first terminal device and from the network device, a resource configuration for sidelink, wherein the resource configuration indicates the first number of sidelink feedback reception occasions in the set of sidelink feedback reception occasions, and the sidelink configuration further indicates the first number of sidelink feedback reception occasions in the set of sidelink feedback reception occasions.

In some embodiments, the first number of sidelink feedback reception occasions is configured per carrier, or the first number of sidelink feedback reception occasions is configured per bandwidth part, or the first number of sidelink feedback reception occasions is configured per resource pool.

In some embodiments, the terminal device comprises circuitry configured to determine the second number of sidelink feedback reception occasions in the set of sidelink feedback reception occasions based on a traffic packet delay budget or a priority of the set of sidelink transmissions, and the sidelink configuration indicates the second number of sidelink feedback reception occasions in the set of sidelink feedback reception occasions.

In some embodiments, the terminal device comprises circuitry configured to receive, from one of the set of terminal devices, an indication of a listen-before-talk failure; and transmit, to the network device, the uplink transmission indicating a NACK for the set of sidelink transmissions.

In some embodiments, the sidelink configuration further indicates that a sidelink feedback needs to be transmitted on each sidelink feedback reception occasion of the set of sidelink feedback reception occasions corresponding to the sidelink transmission.

In some embodiments, a time gap between two adjacent sidelink transmissions in the set of sidelink transmissions comprises: a first time gap between an end of a last symbol of a first sidelink transmission of the set of sidelink transmissions and a start of a first symbol of a starting sidelink feedback reception in the set of sidelink feedback reception occasions, a second time gap between a first symbol of the starting sidelink feedback reception occasion and a first symbol of the last sidelink feedback reception occasion in the set of sidelink feedback reception occasions, and a third time gap required for the last sidelink feedback reception and processing plus sidelink retransmission preparation.

In some embodiments, the terminal device comprises circuitry configured to transmit the uplink transmission by: transmitting the uplink transmission within a first slot with a slot offset, wherein the first slot is the slot of a starting sidelink feedback reception occasion in the last set of sidelink feedback reception occasions.

In some embodiments, the slot offset is larger than the number of slots which are occupied by the last set of sidelink feedback reception occasions.

In some embodiments, the terminal device comprises circuitry configured to receive, from one of the set of terminal devices, an indication of a listen-before-talk failure; and transmit, to a network device, the uplink transmission indicating hybrid automatic repeat request (HARQ)-ACK information which is preconfigured by the network device.

In some embodiments, a terminal device comprises circuitry configured to receive, from a first terminal device, a sidelink configuration, wherein the sidelink configuration indicates that one sidelink transmission corresponds to one set of sidelink feedback reception occasions and the sidelink configuration also indicates that a sidelink feedback type for the sidelink transmission is negative acknowledgement only (NACK-only); and receive a set of sidelink transmissions from the first terminal device.

In some embodiments, the sidelink configuration further indicates the first number of sidelink feedback reception occasions in the set of sidelink feedback reception occasions.

In some embodiments, the terminal device comprises circuitry configured to perform a listen-before-talk before transmitting a sidelink feedback for a sidelink transmission of the set of sidelink transmissions; and in accordance with a determination that the listen-before-talk is failed, transmit, to the first device, an indication of a listen-before-talk failure.

In some embodiments, the sidelink configuration further indicates that a sidelink feedback needs to be transmitted on each sidelink feedback reception occasion of the set of sidelink feedback reception occasions corresponding to the sidelink transmission.

In some embodiments, a time gap between two adjacent sidelink transmissions in the set of sidelink transmissions comprises: a first time gap between an end of a last symbol of a first sidelink transmission of the set of sidelink transmissions and a start of a first symbol of a starting sidelink feedback reception in the set of sidelink feedback reception occasions, a second time gap between a first symbol of the starting sidelink feedback reception occasion and a first symbol of the last sidelink feedback reception occasion in the set of sidelink feedback reception occasions, and a third time gap required for the last sidelink feedback reception and processing plus sidelink retransmission preparation.

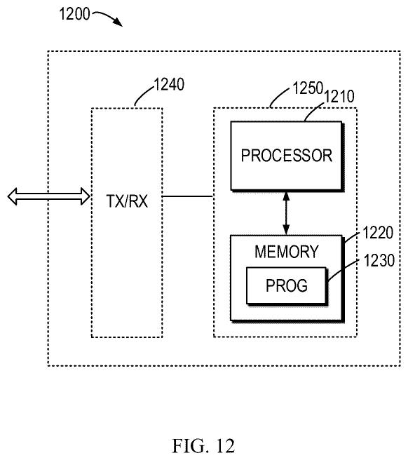

FIG. 12 is a simplified block diagram of a device 1200 that is suitable for implementing embodiments of the present disclosure. The device 1200 can be considered as a further example implementation of the terminal device 110-1 or the network device 120 as shown in FIG. 2. Accordingly, the device 1200 can be implemented at or as at least a part of the terminal device 110-1 or the network device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1220 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIG. 2 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 2700. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

1.-18. (canceled)

19. A method performed by a terminal device, the method comprising:
receiving configuration information for a resource pool; and
determining a first time gap between an end of a last symbol of a first physical sidelink shared channel (PSSCH) of a first resource and start of a first symbol of a last PSFCH reception corresponding to the first PSSCH based on the configuration information.

20. The method of claim 19, wherein the first time gap is comprised in a second time gap, and the second time gap is between the first resource for the first PSSCH and a second resource for a second PSSCH.

21. The method of claim 19, wherein the configuration information comprises sl-MinTimeGapPSFCH and sl-PSFCH-Period for the pool of resources, and the first time gap is determined by sl-MinTimeGapPSFCH and sl-PSFCH-Period.

22. The method of claim 20, wherein the second time gap further comprises a time required for PSFCH reception and processing plus sidelink retransmission preparation including multiplexing of necessary physical channels and any transmitting (TX)-receiving(RX)/RX-TX switching time.

23. The method of claim 20, further comprising:
transmitting the first PSSCH in the first resource; and
transmitting the second PSSCH in the second resource.

24. The method of claim 19, wherein the method is performed on a shared spectrum by the terminal device.

25. A terminal device comprising a processor configured to cause the terminal device to:
receive configuration information for a resource pool; and
determine a first time gap between an end of a last symbol of a first physical sidelink shared channel (PSSCH) of a first resource and start of a first symbol of a last PSFCH reception corresponding to the first PSSCH based on the configuration information.

26. The terminal device of claim 25, wherein the first time gap is comprised in a second time gap, and the second time gap is between the first resource for the first PSSCH and a second resource for a second PSSCH.

27. The terminal device of claim 25, wherein the configuration information comprises sl-MinTimeGapPSFCH and sl-PSFCH-Period for the pool of resources, and the first time gap is determined by sl-MinTimeGapPSFCH and sl-PSFCH-Period.

28. The terminal device of claim 26, wherein the second time gap further comprises a time required for PSFCH reception and processing plus sidelink retransmission preparation including multiplexing of necessary physical channels and any transmitting (TX)-receiving(RX)/RX-TX switching time.

29. The terminal device of claim 26, the terminal device is further caused to:
transmit the first PSSCH in the first resource; and
transmit the second PSSCH in the second resource.

30. The terminal device of claim 25, wherein the terminal device is caused to perform on a shared spectrum.
